(19) United States
(12) Patent Application Publication
(10) Pub. No.: US 2009/0149249 A1
(43) Pub. Date: Jun. 11, 2009

(54) GAMING MACHINE SYSTEM UTILIZING VIDEO DISPLAYS COMPRISING ORGANIC LIGHT EMITTING DIODES

(75) Inventor: Benny Sum, Las Vegas, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: GLOBAL GAMING GROUP, INC., Las Vegas, NV (US)

(21) Appl. No.: 12/388,905

(22) Filed: Feb. 19, 2009

Related U.S. Application Data
(63) Continuation-in-part of application No. 11/866,668, filed on Oct. 3, 2007.

(51) Int. Cl. A63F 13/00

(52) U.S. Cl. 463/30

(57) ABSTRACT

A video game machine including one or more display devices utilizing organic light emitting diodes (OLEDs) or functionally equivalent technology to display moving and/or static information on curved portions of a display device such that the activity of the video reels flat slot machine display resembles the activity of mechanical reels, and so that user interface buttons and screens are more appealing. To facilitate fabrication of the curved portions of the display device, flexible OLED technology may be employed.

### CROSS REFERENCE TO RELATED APPLICATIONS

This application is a Continuation-In-Part of U.S. patent application Ser. No. 11/866,668 which was filed on Oct. 3, 2007.

### BACKGROUND OF THE INVENTION

1. Field of the Invention

The embodiments of the present invention relate generally to slot machines. More particularly, the embodiments of the present invention relate to configuring video reels, screens and/or buttons to appear with configurable, illuminated curved outer surfaces.

2. Related Art

Slot machines now dominate casino floors. Indeed, table games are being squeezed by the expanding real estate being utilized by slot machines and similar electronic gaming machines. The rise in the popularity of slot machines has directly impacted the technological advances associated with slot machines. Accordingly, a majority of newly developed and manufactured slot machines are video based.

Traditional reel slot machines include three rotating mechanical game reels. The game reels depict various slot symbols, which based on alignment along one or more pay lines, determine a game payout. On the other hand, video slot machines utilize a flat or generally flat screen or monitor to display video slot symbols moving from top to bottom. Like the mechanical slot machines, payouts are based on an alignment of slot symbols along one or more pay lines. Video slot machines are much more versatile than mechanical slot machines. For example, a video slot machine may offer 30 pay lines or more while a mechanical slot machine may offer only 5 pay lines. In addition, with video, individual slot symbols can take on an infinite number of forms and shapes, and the symbols can be animated. Video slot machines are also easier to maintain than traditional mechanical slot machines.

However, despite the inherent advantages of video slot machines, many players do not like them and prefer mechanical slot machines. Particularly, players that were introduced to slot machines via traditional hard reel machines tend to enjoy the traditional slot machines. In fact, in many instances, these players do not play video slot machines. One primary reason for the dislike is the “video game feel” associated with video slot machines.

Thus, there is a need for a video slot machine system that creates an appearance of a traditional mechanical slot machine while retaining the benefits that video machines offer. Advantageously, the video-based machine system should be useable on all types of gaming machines, including video poker machines, keno machines, bingo machines and the like.

Furthermore, there is a need to maintain the traditional “look and feel” of a mechanical slot machine, while at the same time reducing its cabinet size and adapting it to video play functionality.

And still further, there is a need to upgrade buttons, screens and other player interfaces with more appealing, user-friendly features. By making user interfaces more appealing, players will be more attracted to a video slot machine, and will play the game for a longer period of time.

### SUMMARY OF THE INVENTION

Accordingly, one embodiment of the present invention comprises: a gaming machine housing; a processor to control a video-based game facilitated by the gaming machine; one or more player interfaces operable to allow a player to play the video-based game on the gaming machine; and a gaming machine display device utilizing organic light emitting devices for displaying game symbols.

A second embodiment of the present invention comprises: a slot machine housing; a processor to control a video-based slot machine game; one or more player interfaces operable to allow a player to play the slot machine game; and a slot machine display device comprising one or more outwardly curved portions utilizing organic light emitting devices, said curved portions adapted to display moving and static video reel symbols.

In general, the embodiments of the present invention utilize organic light emitting diodes (OLEDs) to display moving and static game symbols on curved portions of a display device such that the activity of the video reels, unlike the currently available flat slot machine display devices, resembles the activity associated with mechanical reels thereby attracting all types of players. Similarly, user interface buttons and screens can be curved inwardly or outwardly to attract players. To facilitate fabrication of the curved portions of the various display devices, flexible OLED technology may be employed as detailed below.

Other variations, embodiments and features of the present invention will become evident from the following detailed description, drawings and claims.

### BRIEF DESCRIPTION OF THE DRAWINGS

FIG. 1 illustrates a front view of a conventional mechanical slot machine;

FIG. 2 illustrates a perspective view of the conventional slot machine with interior components exposed;

FIG. 3 illustrates a conventional video slot machine;

FIG. 4 illustrates an exemplary configuration of an Organic Light Emitting Diode structure;

FIG. 5 illustrates an exemplary configuration of an Active Matrix Organic Light Emitting Diode structure;

FIG. 6 illustrates a front view of one embodiment of a video slot machine display device of the present invention;

FIG. 7 illustrates a perspective view of the embodiment of a video slot machine display device of the present invention as shown in FIG. 6;

FIG. 8 illustrates a side view of the embodiment of the video slot machine display device as shown in FIG. 6;

FIG. 9 illustrates a top view of the embodiment of the video slot machine display device as shown in FIG. 6;

FIG. 10 illustrates a perspective view of an alternative embodiment of a slot machine display device of the present invention;

FIG. 11 illustrates a top view of the alternative embodiment of a slot machine display device of the present invention as shown in FIG. 10;

FIG. 12 illustrates a cross-sectional view of the video slot machine monitor of the present invention;

FIG. 13 is a fragmentary perspective view of a video slot machine according to the subject invention including a curved video display, together with various user interface screens and buttons having configurable, illuminated curved outer surfaces;

FIG. 14 is an enlarged view of the user interface region for the video slot machine depicted in FIG. 13;

FIG. 15 is a side elevation view of a video slot machine according to the subject invention, illustrating the imaginary diameter (D) represented by the curved outer surfaces of the video display; and

FIG. 16 is a depiction of the hypothetical video strip reel for one of the video reels used in the video slot machine of the subject invention.

### DETAILED DESCRIPTION OF THE PREFERRED EMBODIMENT

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to a person skilled in the relevant art and having possession of this disclosure, are to be considered within the scope of the invention claimed.

The operation of slot machines and other gaming machines is controlled by microprocessors which communicate with internal memory devices and the external features of the machines. The microprocessors also incorporate, or communicate with, a random number generator which ensures the randomness of the machines' outcomes. In the embodiments of the present invention, one or more processors, along with memory and related devices, control the machines' disclosed herein. Since the technology for operating and controlling gaming machines is well known to those skilled in the art, the subtle operational details are not described herein.

While standalone gaming machines are referenced herein, those skilled in the art will recognize that gaming machine also refers to and includes server-based and online games which utilize display devices.

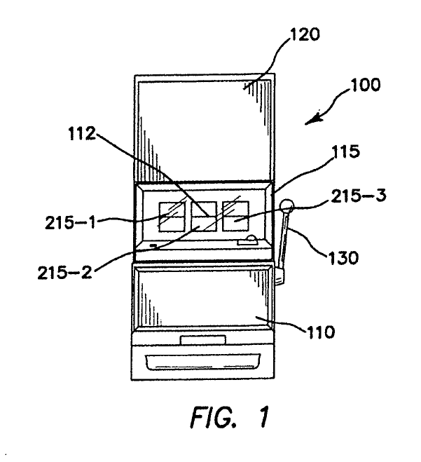

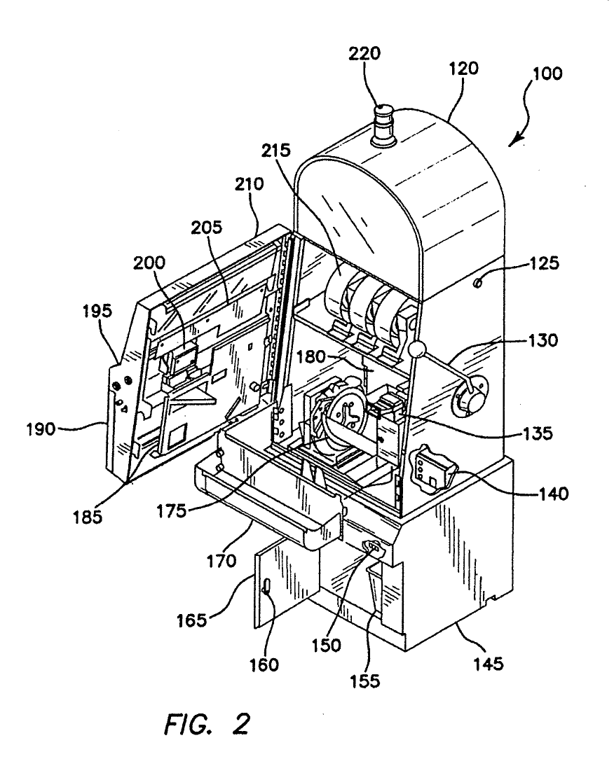

Initial reference is made to FIGS. 1 and 2 illustrating a conventional mechanical slot machine generally denoted by reference numeral 100. The slot machine 100 is a mechanical slot machine having bottom portion 110, central portion 115, top box 120, reset key switch 125, handle 130, bill acceptor 135, power supply 140, stand 145, drop door sensor switch 150, coin drop container 155, drop door lock 160, drop door 165, coin tray 170, hopper 175, processor tray 180, belly panel 185, belly door 190, player panel 195, coin-in assembly 200, digital display 205, machine door 210, mechanical reels 215 and service candle 220. One or more pay lines 112 are located over the reels 215. Most slot machines are also now outfitted with card readers to track player play and coupon acceptors.

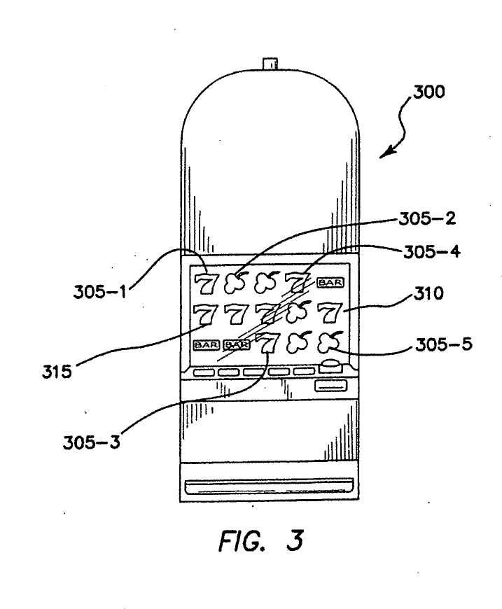

FIG. 3 shows a video slot machine 300. The video slot machine 300 includes five video reels 305-1 through 305-5. The video display 310 allows three video reel symbols 315 on each video reel 305 to be viewed simultaneously. So, in this instance, 15 video reel symbols 315 may be viewed simultaneously. This is unlike mechanical slot machines which do not allow a significant number of reel symbols to be viewed simultaneously because only a small part of the mechanical reel is viewable by the player at any given time.

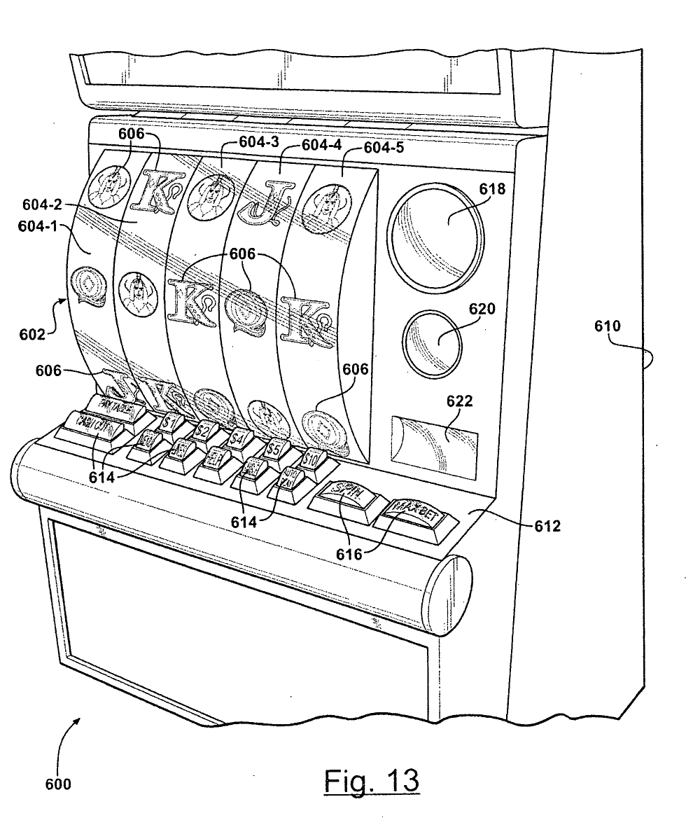

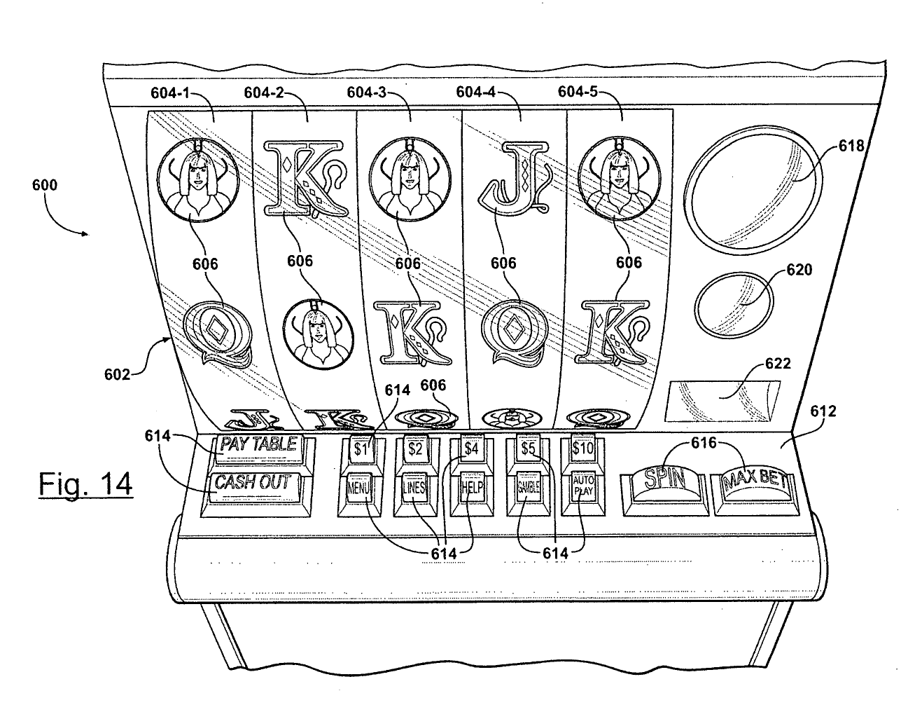

The embodiments of the present invention utilize gaming machine display devices which utilize organic light emitting diodes (OLEDs). These display devices may comprise the video display 310, as well as user interface features like screens and buttons as described below in connection with FIGS. 13-14. OLEDs provide brighter, crisper displays on electronic devices and use less power than light-emitting diodes (LEDs) or liquid crystal displays (LCDs) used today. Advantageously, OLEDs also enable foldable or curved displays to be created. OLED technology as applied to push buttons and switches is known from examples such as US Publication No. 2008/0135388 to Hoehne et al., published Jun. 12, 2008, the entire disclosure of which is incorporated here by reference.

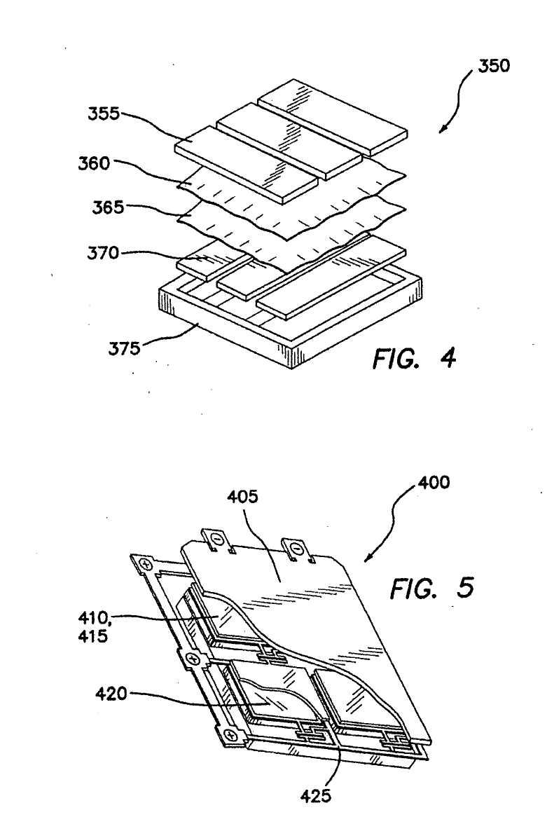

Now referring to FIG. 4, an exemplary OLED structure 350 is shown. The OLED structure 350 comprises various layers, namely a cathode 355, emissive layer 360 comprising organic molecules or polymers, conductive layer 365 comprising organic molecules or polymers, anode 370 and substrate 375. The substrate 375 may be clear plastic, glass or foil and supports the OLED structure 350. The anode 370 is transparent and removes electrons (adds electron “holes”) when a current flows through the OLED structure 350. The conductive layer 365 is made of organic plastic molecules (e.g., polyaniline) that transport “holes” from the anode 370. The emissive layer 360 is made of organic plastic molecules (different from the ones used in the conductive layer 365)(e.g., polyfluorene) that transport electrons from the cathode 355 causing light to be made. The cathode 355, which may or may not be transparent, injects electrons when a current flows through the OLED structure 350.

OLEDs emit light through a process known as electrophosphorescence. In one practical process, a battery, power supply or external power source applies a voltage across the OLED structure 350 causing the flow of electric current (i.e., the flow of electrons) from the cathode 355 to anode 370 through the organic layers 360, 365. As a result, the cathode 355 gives electrons to the emissive layer 360 and the anode 370 removes electrons from the conductive layer 365. At the boundary between the emissive layer 360 and conductive layer 365, electrons find electron holes. When an electron finds an electron hole, the electronic fills the hole causing the electron to give up energy in the form of a photon of light. The color of the light depends on the type or organic molecule in the emissive layer 360. Manufacturers place several types of organic films on the same OLED structure to make color displays. The brightness of the emitted light is controlled by the amount of electrical current applied. The more current applied the brighter the light.

There are numerous types of OLED structures including passive-matrix, active-matrix, transparent, top-emitting, foldable and white. While any may be used to facilitate the embodiments of the present invention, the active-matrix and foldable OLEDs are focused on herein. It should be understood that while OLED technology represents the preferred underlying technology for illuminating display devices throughout a video slot machine according to this invention, other technologies may be substituted and produce acceptable results. For example, technologies which are known for flat panel computer displays, television monitors, touch screen displays and the like, which operate on principles other than OLED technology may be adapted for use in this invention.

FIG. 5 shows an active-matrix OLED 400 (AMOLED) having layers of cathode 405, organic layers 410, 415 and anode 420 with the anode layer 420 overlaying a thin film transistor (TFT) array 425 that forms a matrix. The TFT 425 is circuitry that determines which pixels get turned on to form an image. AMOLEDs are efficient for large displays and have fast refresh rates making them suitable for video displays. Foldable OLEDs have substrates made of very flexible metallic foils or plastics and are lightweight and durable.

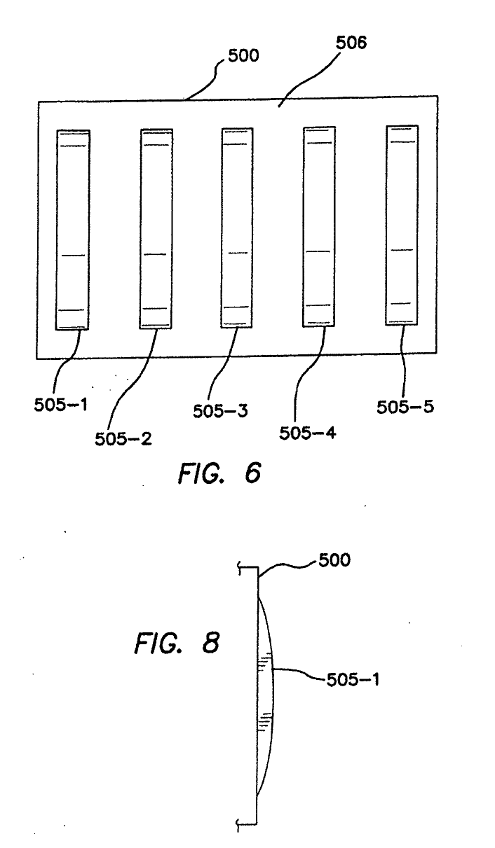

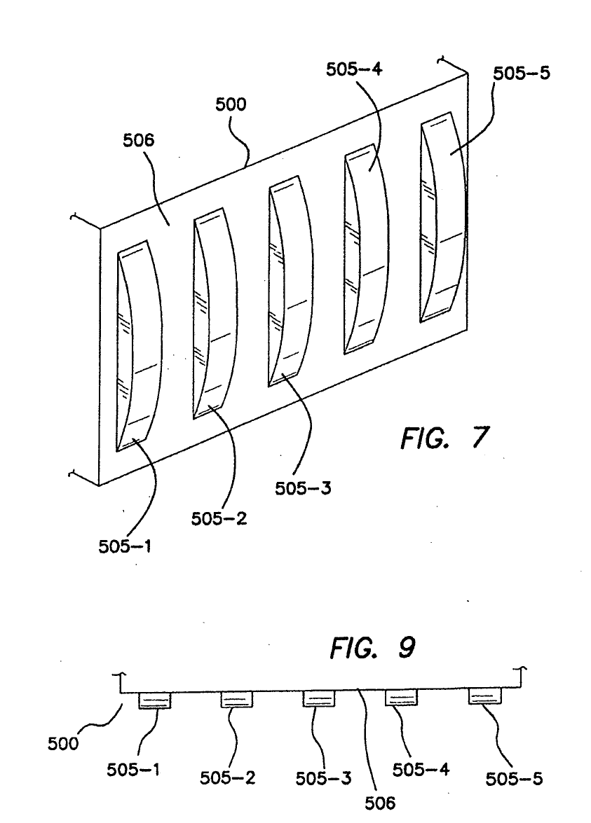

FIGS. 6 through 9 show a front view, perspective view, side view and top view, respectively, of a slot machine display device 500 utilizing foldable or flexible OLEDs (e.g., AMOLEDs) to form five curved portions 505-1 through 505-5 which act as game reels to display gaming symbols (not shown). The curved portions 505-1 through 505-5 display static and dynamic video game symbols thereby creating the effect of mechanical reels with the use of video. As the video images of the gaming symbols are dynamically displayed on the curved portions 505-1 through 505-5, it appears as through the video images of the gaming symbols are rotating in manner akin to mechanical hard reels. In other words, the video images of the gaming symbols are no longer being displayed on a flat display device, but are being displayed on the curved portions 505-1 through 505-5.

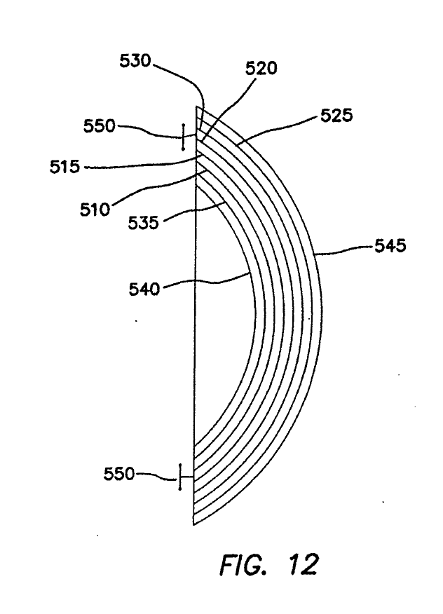

A cross-sectional view of a curved portion 505 (along A) is shown in FIG. 12. In one embodiment, an AMOLED having a cathode layer 510, emissive layer 515, conductive layer 520, anode layer 525 and a TFT array 530 overlaid by said anode layer 525 is used. A substrate 535 made of very flexible metallic foils or plastics is attached to or rests on rigid curved member 540 to create the curved appearance of curved portion 505. To prevent damage, a durable transparent cover 545 may be positioned over said AMOLED structure. Electrical contacts 550 at one or both ends of the curved portion 505 provide means for the required voltage to be supplied to the AMOLED.

Like traditional slot machines, the OLED display device is powered by an external energy source in the form of electricity. The OLED display devices of the embodiments of the present invention may be retrofitted onto existing slot machines or integrated into newly built slot machines.

As shown in FIGS. 6-9, the curved portions 505-1 through 505-5 occupy only a portion of the display device 500. In other words, a portion of the display device 500 remains flat. The flat portion 506 may be an active flat panel display suitable for display images in conjunction with the curved portions 505 or may be inactive and designed to provide support for the curved portions 505.

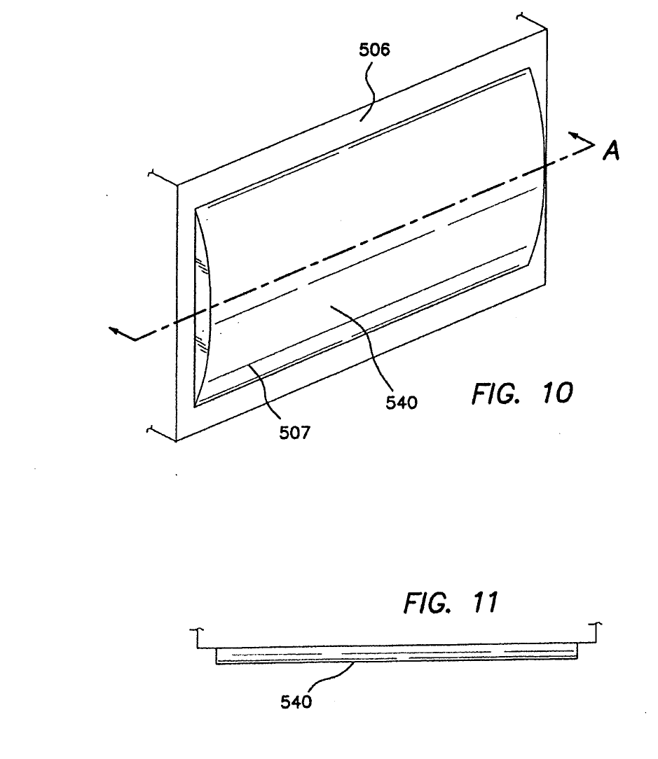

FIGS. 10 and 11 show a perspective view and top view, respectively, of a single curved portion 540 that can be used to display five video reels a separated by lines 507. Any number of reels may be simulated with any of the embodiments of the present invention.

While the OLED display device described herein has been limited to the game display, it will be recognized by those skilled in the art that the embodiments of the present invention may also be integrated into gaming machine topper display devices used to facilitate bonus games or on other locations on the slot machine as described below. Display devices used with server-based and online games may also benefit from the embodiments or the present invention described herein. In such configurations, a PC display device or similar display device may include the flexible, curved portions facilitated by OLED technology or other technology.

Referring now to FIGS. 13-15, a video slot machine according to the subject invention is generally shown at 600. As with preceding examples, the video slot machine 600 includes a video display 602 having outwardly curved portions 604-1 to 604-5. Each curved portion 604-1 through 604-5 acts as a game reel displaying symbols 606 used during the play of a video style slots game. These symbols 606 are expected to change from one game title to the next, and are shown in these figures merely as exemplary. Using OLED, AMOLED, or other illumination technology capable of display over a curved surface, the symbols 606 are computer generated and projected onto the curved portions 604-1 through 604-5 in a manner to mimic, preferably, the motions of a traditional mechanical reel slot machine.

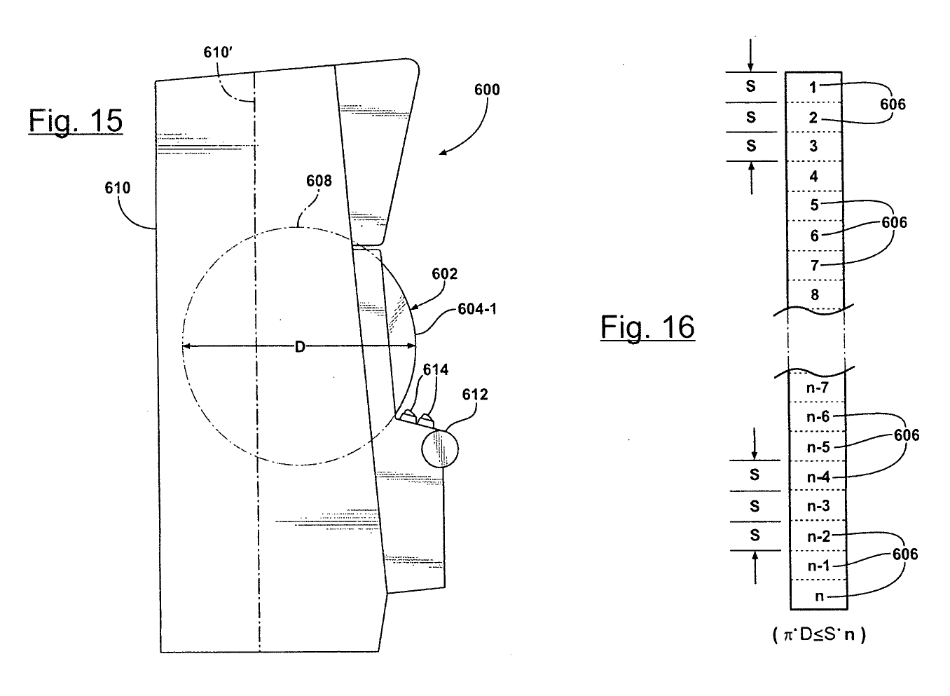

As perhaps best shown in FIG. 15, the curved portions 604-1 through 604-5 may take the form of a sector having a semi-cylindrical curvature defined by an imaginary full circle 608 having a diameter D. The video slot machine 600 includes a cabinet or housing having a back panel 610. In a traditional mechanical reel slot game, the spinning reels are completely enclosed within the cabinet, such that the diameter of the reels does not extend beyond the back panel. However, in the subject video slot machine 600, it is possible to reduce the overall depth of the machine cabinet, by moving the back panel to the position shown in phantom at 610′. Thus, through advantages only achievable through use of the subject invention, it is possible to form the curved portions 604-1 through 604-5 having a curvature defined by an imaginary circle 608 having a diameter D that extends beyond the back panel 610′. Thus, the video slot machine 600 can be made smaller, if desired, to conserve materials, space, weight and the like, without sacrificing player appeal achieved by mimicking traditional mechanical reel type slot machines.

FIG. 16 represents and exemplary, hypothetical strip reel containing symbols 606 used in the play of a game on the video slot machine 600. The symbols 606 are arranged in a column which represents their virtual arrangement and order around a slot reel. Each symbol 606 occupies a character space S such that its distance from the next adjacent symbol 606 is generally fixed throughout play of the game. All of the spaces added together, or S*N where N represents the total number of symbols 606, is typically equal to the circumference of the full circle 608. Circumference is calculated by multiplying π times the diameter D. Thus, in a game system configured to perfectly replicate a traditional reel slots game of the mechanical variety, the circumference (πD) will be equal to S*N. However, in an alternative embodiment enabled through use of the subject invention, it is possible to alter the number N of symbols 606 so that more symbols 606 are used than could be fit around the circumference of the full circle 608. In this example, the circumference of the full circle 608 (πD) is less than S*N. The average player will be unable to perceive a scenario where πD is less than S*N and therefore game proprietors and casinos will be able to change games in the video slot machine 600 having different numbers N of symbols 606, and thus different mathematics and payback tables, without altering the external features of the video slot machine 600. Thus, the subject invention is readily adaptable to game play in various jurisdictions without departing from the attractiveness and appeal generated by the video display 602 replicating the look and feel of a traditional mechanical reel slots game.

FIGS. 13 and 14 illustrate the way in which the aforementioned technology can be adapted for use on interface buttons and screens that are curved inwardly, outwardly or domed to further attract player attention and increase game play interest. For example, A player panel 612 is shown including a plurality of push buttons or switches 614, 616 having curved outer surfaces fitted with the novel illumination technology described above such as OLED or AMOLED technology. Using this novel illumination technology applied over a curved outer surface, a processor based control system can project static or animated content that is both useful and attractive to players. Exemplary content contained on the buttons 614, 616 is shown in FIG. 14 by way of example only. Because this content is processor controlled, it can be reconfigured from one game title to the next depending upon that which is loaded into and operating on the video slot machine 600 at any given time. Furthermore, the information communicated on the buttons 614, 616 can be reconfigured within a particular game, for example, if the game play shifts to bonus mode, if the player interacts in a progressive style network, in tournament style play, or other such conditions. The control processor can thus change the information communicated on the buttons 614, 616 and/or animate the outer surface of the buttons 614, 616 in any manner imaginable.

FIGS. 13 and 14 also illustrate, by way of example only, supplemental display screens 618, 620 and 622 arranged alongside the normal video display 602. The supplemental display screens 618-622 may be of the touch screen variety, or simply monitors to communicate information to the player. The uppermost supplemental display screen 618 is shown here having a convexly domed outer surface which is fitted with some technology, like the OLED or AMOLED techniques described above, to present information to the player. Projecting the information over the domed surface of supplemental display screen 618 may provide interest in visual effects. For example, the supplemental display screen 618 may be used to project recorded images of entertainment shows available in the casino or nearby, trailers for upcoming movies, an animated help assistant or the like. The smaller circular display screen 620 is also shown having a convex domed configuration and may be used for other communication purposes, such as advertisements or the like. Of course, rather than being convex, the supplemental display screen 620 could be concave, semi-cylindrical, hyperbolic, conical or the like. The lower supplemental display screen 622 is shown having a concave cylindrical configuration for illustrative purposes only. It may be desirable to inset the curved portion of any one or all of the display screens throughout the video slot machine 600 for various reasons. For example, it may be desirable to utilize the supplemental display screen 622 to present player information of a more private nature, and by insetting the curvature the displayed information is less discernable by adjacent players. Of course, those of skill in this field will readily envision other user interface display features which may be configured and used within the context of this invention.

While slot machines are detailed above, it is apparent that OLED display devices described herein may also be used with other gaming devices, including video poker machines, keno machines and bingo machines. For example, with video poker machines, the display device may incorporate outwardly curved portions using foldable or flexible OLED structures to display the cards in a unique manner.

The embodiments of the present invention offer gaming machine manufacturers more versatility than conventional flat display devices while offering users (i.e., casino patrons) a more exciting and unique gaming experience.

In addition to use in the casino industry, the embodiments of the present invention may similarly be used with skill-based video games (e.g., DOOM). The video game industry generates billions of dollars every year. The use of the OLED curved display devices described herein have many applications that can enhance the play of such skill-based games. Those skilled in the art will recognize that other display technologies may be used to facilitate the embodiments of the present invention.

Although the invention has been described in detail with reference to several embodiments, additional variations and modifications exist within the scope and spirit of the invention as described and defined in the following claims.

What is claimed is:

1. A gaming machine comprising:
a gaming machine housing;
a processor to control a video-based game facilitated by the gaming machine;
one or more player interfaces operable to allow a player to play the video-based game on the gaming machine; and
a gaming machine display device utilizing organic light emitting devices for displaying game symbols.

2. The gaming machine of claim 1 wherein organic light emitting devices are diodes.

3. The gaming machine of claim 1 wherein the entire display device utilizes organic light emitting devices.

4. The gaming machine of claim 1 wherein only a first portion of the display device utilizes organic light emitting devices and a second portion utilizes one or more of the following: cathode ray tubes, liquid crystal, plasma or light emitting diodes.

5. The gaming machine of claim 1 wherein the organic light emitting devices are configured in a flexible or foldable medium.

6. The gaming machine of claim 1 wherein the gaming machine display device includes one or more curved portions extending outwardly, said curved portions acting as game reels.

7. The gaming machine of claim 6, wherein said curved portions are semi-cylindrical as defined by an imaginary full circle, and wherein the diameter of said imaginary full circle penetrates a back panel of the gaming machine housing.

8. The gaming machine of claim 6, wherein said curved portions are semi-cylindrical as defined by an imaginary full circle, and wherein the number of predefined game symbols displayed on the game reels multiplied by the character space allotted to each symbol is greater than the circumference of the imaginary full circle.

9. The gaming machine of claim 1 wherein the display device is used to facilitate a primary game.

10. The gaming machine of claim 1 wherein the display device is used to facilitate a bonus game.

11. The gaming machine of claim 1 wherein the display device comprises a user interface button.

12. The gaming machine of claim 1 wherein the display device comprises a supplemental display screen.

13. The gaming machine of claim 1 further comprising a durable transparent cover positioned over said display device.

14. A slot machine comprising:
a slot machine housing;
a processor to control a video-based slot machine game;
one or more player interfaces operable to allow a player to play the slot machine game; and
a slot machine display device comprising one or more outwardly curved portions, said curved portions adapted to display moving and static video reel symbols.

15. The slot machine of claim 14 further comprising utilizing organic light emitting devices for the outwardly curved portions.

16. The slot machine of claim 15 wherein said organic light emitting devices are diodes.

17. The slot machine of claim 15 wherein the organic light emitting devices are configured in a flexible or foldable medium.

18. The slot machine of claim 15, wherein said curved portions are semi-cylindrical as defined by an imaginary full circle, and wherein the diameter of said imaginary full circle penetrates a back panel of the gaming machine housing.

19. The slot machine of claim 15, wherein said curved portions are semi-cylindrical as defined by an imaginary full circle, and wherein the number of predefined game symbols displayed on the game reels multiplied by the character space allotted to each symbol is greater than the circumference of the imaginary full circle.

20. The slot machine of claim 15 further comprising a durable transparent cover positioned over said display device.

21. A method of facilitating a game on a video-based slot machine comprising:
programming a processor to control said game;
utilizing a display device integrating organic light emitting diodes and having one or more outwardly curved portions wherein said curved portions of said display device are flexible; and
displaying dynamic game symbols on said curved portions wherein the curved portions act as game reels.

22. The method of claim 21 further comprising providing a payout based on an alignment of game symbols along one or more active pay lines.

23. The method of claim 21, wherein said step of displaying dynamic game symbols includes projecting the game symbols in a semi-circular path.

24. The method of claim 23, wherein the semi-circular path is defined by an imaginary full circle that extends beyond the slot machine.

25. The method of claim 21, further including the step of displaying game information on the curved portions wherein the curved portions include at least one user interface.
